(19) United States
(12) Patent Application Publication
(10) Pub. No.: US 2024/0331329 A1
(43) Pub. Date: Oct. 3, 2024

(54) METHOD AND SYSTEM FOR SUPERIMPOSING TWO-DIMENSIONAL (2D) IMAGES OVER DEFORMED SURFACES

(71) Applicant: The Governors of the University of Alberta, Edmonton (CA)

(72) Inventors: Gregory Neil Kawchuk, Edmonton (CA); Jacob Versluys, Edmonton (CA)

(21) Appl. No.: 18/620,312

(22) Filed: Mar. 28, 2024

Related U.S. Application Data
(60) Provisional application No. 63/492,558, filed on Mar. 28, 2023.

(51) Int. Cl. G06T 19/20; G06T 7/73; G06T 15/00; G06T 17/20

(52) U.S. Cl. CPC G06T 19/20; G06T 7/75; G06T 15/00; G06T 17/20; G06T 2207/10028; G06T 2210/62; G06T 2219/2004; G06T 2219/2016; G06T 2219/2021

(57) ABSTRACT

Embodiments herein generally relate to a method and system for superimposing two-dimensional (2D) images over deformed surfaces. In at least one embodiment, there is provided a method for superimposing a two-dimensional (2D) image onto a surface, comprising: pre-processing the 2D image to generate a pre-processed 2D image, wherein the pre-processing comprises assigning one or more pixels in the 2D image as image anchor points; receiving image data and depth sensor data, of a surrounding environment, from at least one sensor; processing the depth sensor data to generate a three-dimensional (3D) world mesh; determining a target placement area, on the 3D world mesh, for superimposing the 2D image, wherein the target placement area is located on a deformed surface; and superimposing the transformed image over the target placement area.

### CROSS-RELATED APPLICATIONS

The present application claims the priority benefit of U.S. Provisional Application 63/492,558, filed on Mar. 28, 2023, the entire contents of which are incorporated herein by reference.

### FIELD

The present invention generally relates to the field of augmented reality, and more particularly, to a method and system for superimposing two-dimensional (2D) images over deformed surfaces (e.g., curved surfaces).

### BACKGROUND

Various technologies have been used to project two-dimensional (2D) images onto flat surfaces in the real world (e.g. screens, walls). Whether it be with classic film projection or modern home video projectors, the quality of the resulting projection depends greatly on the alignment between the projector and the viewing surface. If the projector and the surface are not perpendicular, or if the target surface is uneven or curved, the projected image may appear distorted. The resulting image distortion is not only off-putting visually, it may lead to measurement or errors if the projected image is being used to guide activities or place objects.

### SUMMARY OF VARIOUS EMBODIMENTS

In at least one broad aspect, a method for superimposing a two-dimensional (2D) image onto a surface, comprising: pre-processing the 2D image to generate a pre-processed 2D image, wherein the pre-processing comprises assigning one or more pixels in the 2D image as one or more image anchor points; receiving image data and depth sensor data, of a surrounding environment, from at least one sensor; processing the depth sensor data to generate a three-dimensional (3D) wire mesh; determining a target placement area, on the 3D world mesh, for superimposing the 2D image, wherein the target placement area is located on a deformed surface; superimposing the transformed image over the target placement area.

In some examples, wherein the deformed surface has a degree of curvature.

In some examples, wherein the target placement area is determined by specifying one or more position selection points and the transformed image is superimposed by aligning the one or more anchor points with the one or more position selection points.

In some examples, wherein the one or more image anchor points are designated as one or more image corners.

In some examples, two or more 2D images are superimposed and the pre-processing step, the target placement area determination step and the image superimposition step are repeated for each additional 2D image.

In some examples, the method further comprising specifying different position selection points for the two or more 2D images.

In some examples, the 2D image or each 2D image is adjusted to a desired transparency level, scaling size, and orientation.

In some examples, the target placement area is determined automatically.

In some examples, the automatic determination of a target placement area comprises a pose-detection algorithm for determining at least one landmark or feature on the surface.

In some examples, the method further comprising the step of geometrically calculating the position of the at least one landmark or feature.

In some examples, the method further comprising the step of estimating the target placement area on a subject's body by implementation of an artificial intelligence model, trained to use pose detection data together with features of the subject.

In some examples, the deformed surface is a skin surface of a subject and the 2D image is a diagnostic image.

In some examples, the diagnostic image is an X-ray, a CT scans or an MRI image.

In some examples, the one or more image anchor points comprises an image of an anatomical feature.

In some examples, the deformed surface is a skin surface of person and the 2D image is a tattoo image.

In another broad aspect, there is provided a system for superimposing a two-dimensional (2D) image onto a deformed surface, comprising: at least one sensor configured to generate image data and depth sensor data; at least one processor configured to perform the method of any one of the preceding paragraphs; and a projector for superimposing the 2D image over the target placement area.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an illustration of an example two-dimensional (2D) image being superimposed over a deformed surface.

FIG. 2A shows an example diagnostic image superimposed over a subject's back.

FIG. 2B shows an example tattoo image superimposed over a subject's back.

FIG. 2C shows a composite image comprising a three-dimensional (3D) world mesh overlaid over an image of a subject's back.

FIG. 3A shows an example method for superimposing a 2D image onto a target surface (e.g., a deformed surface).

FIG. 3B shows an example method for generating a transformed image, from an input 2D image.

FIG. 4A is another illustration of an example two-dimensional (2D) image being superimposed over a deformed surface.

FIG. 4B is an illustration of the introduction of the 2D mesh portion and a 3D deformed surface.

FIGS. 4C to 4L illustrate a target surface and an image mesh and in various parts of an alignment process.

FIG. 5 shows an example system for superimposing two-dimensional images onto deformed surfaces.

FIG. 6 is an example simplified hardware/software block diagram for a user device.

Further aspects and features of the example embodiments described herein will appear from the following description taken together with the accompanying drawings.

### DETAILED DESCRIPTION OF THE EMBODIMENTS

### I. Definitions

Any term or expression not expressly defined herein shall have its commonly accepted definition understood by a person skilled in the art. As used herein, the following terms have the following meanings.

“Contour-Corrected Image” refers to a three-dimensional (3D) image object having the same, or substantially the same, geometric profile as a target deformed surface (e.g., same curved profile). Accordingly, when the contour-corrected image is superimposed over the deformed surface, it warps over and around the surface (e.g., complements or mates with the deformed surface profile).

“Deformed Surface” refers to any surface that is non-planar and/or non-flat. In some examples, this includes a surface with any type and/or degree of curvature (e.g., convex surface, or hybrid concave/convex). The surface can also be fully curved, or only partially curved.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

### II. General Overview

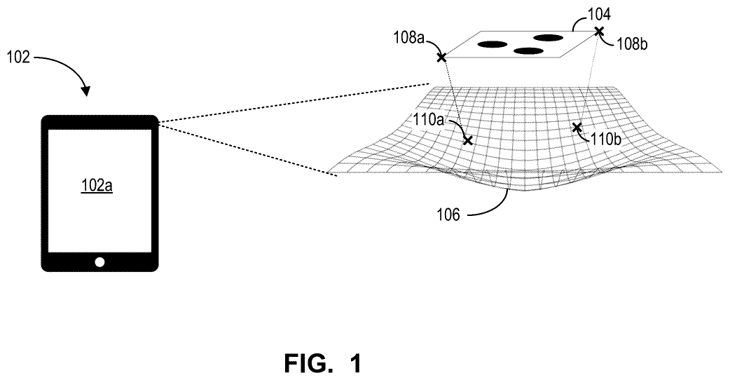

FIG. 1 shows an example use-case for embodiments described herein. As shown, a user device (102) is provided, which includes a display interface (102a). User devices (102) is any suitable computing device, and may include mobile devices such as smartphones, tablets, laptops, smart glasses, goggles or the like.

User device (102) may host one or more software programs (e.g., applications) for superimposing 2D images (104) onto target surfaces (106). The target surfaces (106) include any surfaces located in the surrounding environment (e.g., a table, a floor or a human body). In use, the software program generates, on display interface (102a), the 2D image projected (e.g., superimposed) over the target surface (106). In this manner, the user is provided with an augmented reality experience, whereby computer-generated objects appear to be present in the scene, although they do not exist in real life.

Uniquely, disclosed embodiments enable superimposing a 2D image (104) onto a deformed target surface. As used herein, a deformed surface includes a surface with any degree of curvature. For example, in FIG. 1, the target surface (106) is defined by a curved concave geometry. In other examples, the target surface (106) has any other type and/or degree of curvature (e.g., convex surface, or hybrid concave/convex). The surface can also be fully curved, or only partially curved.

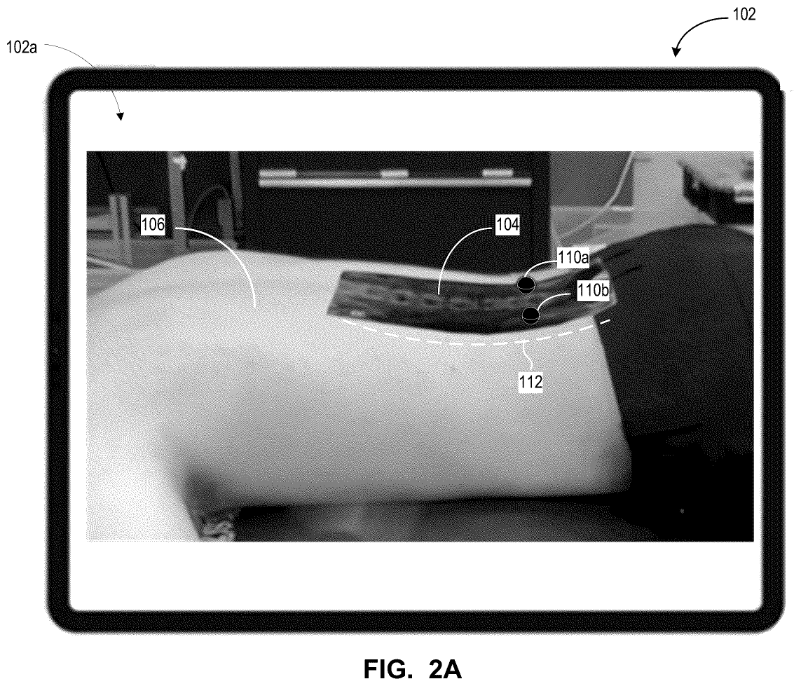

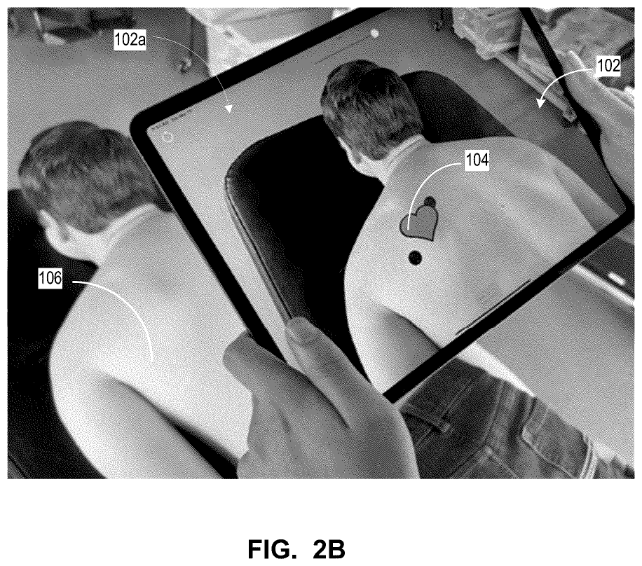

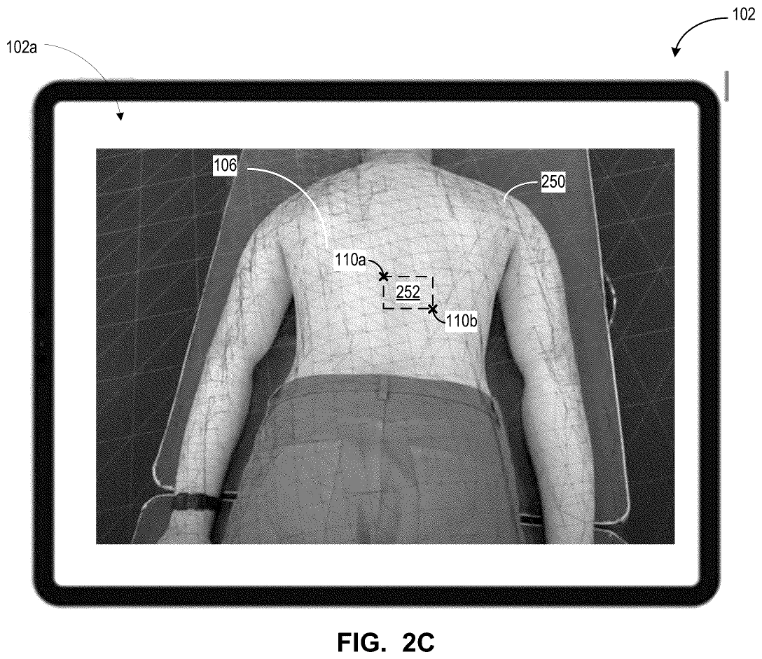

To clarify this concept, reference is briefly made to FIG. 2A. In this example, the software application superimposes a diagnostic image (104) over a subject's back (106). The diagnostic image can be an 2D X-ray image, a CT scan or the like.

The subject's back is curved (112), and therefore represents a deformation. To accommodate the deformation, the 2D image (104) is scaled and transformed to generate a “contour-corrected” image. The contour-corrected image has the same, or substantially the same, geometric profile as the surface (e.g., same curved profile). Accordingly, when the contour-corrected image is superimposed over the surface, it warps over and around the surface. This is contrasted to many existing systems, which are limited to only superimposing flat 2D images over flat regular surfaces.

In at least one embodiment, configuration parameters, of the contour-corrected image, are updated in real-time, or near real-time, with movement of the user device (102) and/or target surface (106). As used herein, configuration parameters for an image comprise any adjustable property of the image including, for example, the scale, warping parameters, shape, position and orientation of the image.

For instance, as the user device (102) moves, or changes perspective, relative to the target surface (106), the configuration of the contour-corrected image is updated to display that the image to the user at the same location. Accordingly, from the user's perspective, it appears that the image is locked, and does not distort or otherwise shift in position. The same principle may apply in reverse, where the user device (102) is in static position, and the target surface (106) moves relative to the user device (106). In these examples, it may still appear that the image is locked in-position, relative to the moving target surface.

The systems and/or methods disclosed herein may be implemented in different contexts or for different purposes. In one example, in a medical or healthcare context, diagnostic images are superimposed over a subject's body. For example, in FIG. 2A, an X-ray or CT scan of a patient's spinal cord is superimposed over the patient's back. In this manner, a user can visualize the patient's spinal cord via the user device (102). In some cases, this can guide healthcare procedures, such as stethoscope placement, electrode placement, injection sites and some surgical interventions.

The transparency level of the superimposed image is also adjustable, and may also comprise another configuration parameter. In a medical application, this can facilitate a user interacting with the target surface. For example, a user can apply their hands (or an instrument) to a specific anatomic location on the patient's skin, through the partially or fully transparent image.

The disclosed embodiments are also useful for various educational and entertainment applications. In example educational applications, the technology is used to correctly superimpose educational images onto deformed surfaces. For example, diagnostic images (e.g., anatomic drawings, medical pictures or the like) are superimposed onto human skin to demonstrate the position, depth, location, and/or function of various anatomic structures or physiological functions.

Users can also select from multiple images, individually or concurrently, to view different anatomies at different depths. With the transparency feature, users can additionally interact with the superimposed images to locate specific objects in relation to living humans.

Similarly, in other examples, the technology is useful to project topographical maps onto landscapes to envision geographic or archeological data.

FIG. 2B shows an example entertainment application for the disclosed technology. As shown, the software is used to superimpose a tattoo image onto the subject's body. The tattoo image (104) is transformed to match the curved contours of the subject's skin (106). This allows subjects to pre-assess how a tattoo will look on their body, prior to applying the tattoo. A similar idea is used to project jewelry and clothes onto human skin, or further yet, projecting various graphics and colors onto objects (e.g., cars).

### III. Example Methods

The following is a description of various example methods for implementing the disclosed embodiments.

### (i.) General Method

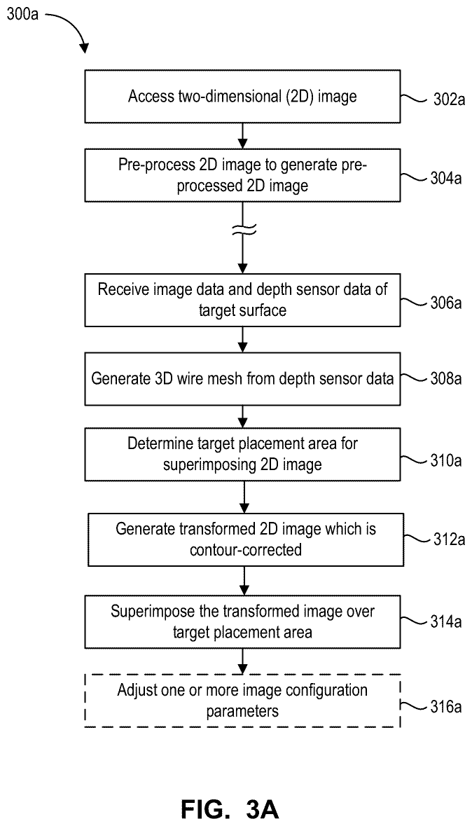

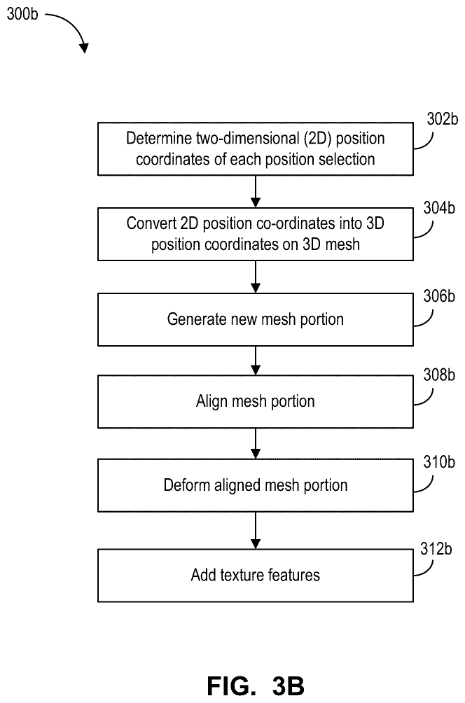

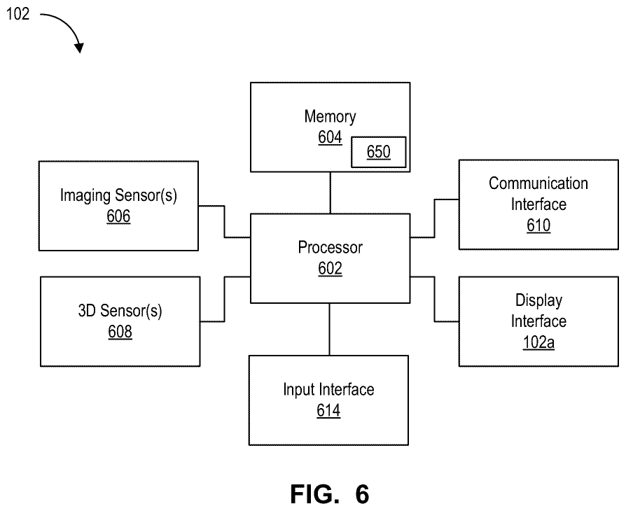

FIG. 3A shows an example method (300a) for superimposing a 2D image onto a surface (e.g., a deformed surface). Method (300a) can be performed by processor (602), of user device (102) (FIG. 6). For example, the processor (602) can execute a software application (650), hosted on a memory of the user device (102).

As shown, at (302a), the software application accesses (e.g., retrieves or receives) an input 2D image. This is the 2D image which is desired to be superimposed onto a real-world surface. The 2D image can comprise an array of pixels (e.g. 640×480 pixel image).

The 2D image may be accessed in various manners. For example, the 2D image can be accessed directly on the user device memory (604) (FIG. 6), or otherwise, on any other memory coupled to the user device (102). In at least one example, the 2D image is accessed (e.g., received) from an external computing device.

In some embodiments, the 2D image is only accessed in response to a user input. For example, the user can select a 2D image from a library of images. This can be performed via the user device's input interface (614). In turn, the system accesses the selected 2D image. In other examples, the 2D image is simply automatically accessed.

At (304a), the input 2D image may be pre-processed to generate a pre-processed input 2D image. For example, if the 2D image does not include a transparent background, the background may be converted into a transparent background. This conversion can be effected using any manner known in the art.

The image pre-processing can also involve converting image pixel coordinates, into percentages. As explained, this facilitates variable size scaling of the 2D image (e.g., to enlarge or reduce image size). The scaling can be performed to accommodate dimensions of the target surface, or otherwise, to accommodate user preferences, by way of non-limiting examples.

In at least one embodiment, converting image pixels to coordinates involves assigning a corner of the image to represent an origin pixel (0,0 pixels). The opposite corner then represents the maximum number of pixels (640,480). The corners are converted into corresponding pixel percentages ([0%,0%] and [100%, 100%], respectively). Every other pixel is allocated an appropriate percentage, based on its intermediate location (e.g., x, y position) between these two corners.

The pre-processing, at (304a), may also involve designating two or more image anchor points, on the 2D image. Each anchor point corresponds to one or more pixels within the 2D image. Each anchor point may be represented by the corresponding pixel percentages (as determined previously).

More generally, the anchor points are used to “anchor” (or align) the image, to a location on a real-world target surface. For example, in FIG. 1, the one or more corners of the 2D image are designated as image anchor points (108a), (108b). A user may then select, on the user device (102), two points on the real-world surface (110a), (110b) to superimpose the 2D image. In turn, the application aligns the anchor points (108a), (108b) to match the position selections (110a), (110b). This involves re-positioning and re-orienting the 2D image, as well as scaling the 2D image to align the image anchor points to the position selections. This process is explained in greater detail, with reference to method (300b) (FIG. 3B).

In other examples, the image anchor points are not necessarily designated as the image corners (as shown in FIG. 1). That is, any other area or region of the 2D image can be designated as an image anchor point. For instance, a selected point in the image, at pixel coordinates of 320, 240—within an image having a size of 640×480—would be represented as an image anchor point at 50%, 50%. In these examples, the disclosed process would still involve aligning the image anchor points to the position selections, on the real-world target surface.

By way of further example, if the image is a diagnostic image (e.g., X-ray or CT scan), specific points within the diagnostic image, corresponding to anatomical landmarks (e.g. spinous processes of vertebrae), could be identified as the image anchor points. Accordingly, when the 2D image is superimposed over a subject's body, the image anchor points are aligned to the relative locations of these landmarks on the subject's body. To that end, the image anchor points can be user-selectable or otherwise automatically designated. With respect to user-selection, the 2D image can be displayed on the display interface (102a), and the user may be allowed to select the desired anchor points using the user device (102).

In other examples, the image anchor points are automatically, or partially-automatically selected. For example, the system can automatically analyze the 2D image to determine specific features or landmarks (e.g., the location of a vertebrae in a diagnostic image). These features or landmarks are then designated as image anchor points. In some examples, the 2D image is processed using a machine learning algorithm, which is trained to automatically detect the target features or landmarks.

At (306a), at a subsequent point in time, one or more sensors are operated to capture image data and depth sensor data of a surrounding environment, which includes the target surface (i.e., the surface to superimpose the 2D image over).

The target surface can be any deformed or non-deformed surface (e.g., including any curved surface), and will vary depending on the example application. In FIGS. 2A and 2B, the target surface is a deformed surface corresponding to the subject's body. In other examples, the target surface can be any other animate or in-animate object (e.g., a table, floor, vehicle, etc.)

The user device (102) may be equipped with an imaging sensor (606) (e.g., an RGB camera) (FIG. 6), which enables capturing two-dimensional (2D) images of the surrounding environment at (306a).

User device (102) can also include a 3D sensor (608) (FIG. 6) to capture depth sensor data. For example, the 3D sensor (608) can be a time-of-flight (ToF) sensor (e.g., a LiDAR sensor), or any other suitable depth sensor. In at least one embodiment, the depth sensor data is stored in the form of point cloud data. Point cloud data represents a discrete set of data points, each associated with a different point in space (e.g., different 3D coordinates).

In some examples, it is also possible that a single sensor has the combined, integrated 2D and 3D imaging functionality. Accordingly, at act (306a), only a single sensor is operated to capture both image and depth sensor data.

Continuing with reference to FIG. 3A, at (308a), the depth sensor data is processed to generate a three-dimensional (3D) wire mesh, corresponding to the imaged surrounding environment (e.g., including the target surface). The 3D world mesh can represent the surrounding environment as polygons. The polygons can be quadrangles or triangles; which can be further broken down into vertices each having corresponding 3D coordinates (e.g., x,y,z) and connected together with lines. It will be understood that any suitable software program, routine or module can be used to generate the 3D world mesh using the point cloud data generated by the depth sensor (608) (e.g., Apple® RealityKit®).

Converting the depth sensor data into a 3D world mesh allows registering the contour topography of the target surface. In turn, this allows transforming the 2D image to warp around the target surface (e.g., a deformed surface).

In some cases, the 3D world mesh is displayed on the user device's display interface (102a). For instance, the 3D world mesh is visualized to the user as a faint series of interconnected red triangles that cover the visible surfaces viewed by the imaging sensor (606), and displayed on the display interface (102a). This is shown, for example, as 3D world mesh (250) in FIG. 2C. As shown, the application may generate a composite image comprising the 3D mesh overlaid over the captured image data.

At (310a), a target placement area is determined for placing the 2D image, in the surrounding environment. The target placement area identifies the area, on a real word target surface, where the 2D image is to be superimposed.

The target placement area may be determined in various manners. In at least one example, the target placement area is determined based on user input selection. For example, the user may input (e.g., select) the target placement area with reference to an image data feed displayed on the user device (102).

In some embodiments, the target placement area is determined via two or more “position selections” (also referred to herein as “touch points”). For example, as shown in FIG. 2C, the user can input two or more position selections (110a), (110b), similar to FIG. 1.

The positions selections can be input at different, or unique locations. For instance a user may view an image feed of the surrounding environment (e.g., a real-time or near real-time video), on the display interface (102a). The user may then select one or more position selections (110a), (110b) on the displayed image frame (e.g., as shown in FIG. 2C).

More generally, position selections (110a), (110b) define the target placement area (252), for the input 2D image. As stated previously, and explained further below, in superimposing the 2D image onto the target surface—the position selections (110a), (110b) are matched and aligned to the image anchor points, in the 2D image. For instance, in FIG. 1, the position selections (110a), (110b) are matched and aligned to the image anchor points (108a), (108b).

In at least some embodiments, the number of required position selections is equal to the number of image anchor points, to allow a one-to-one mapping between position selections and image anchor points.

Once the position selections are input, they may be visualized to the user using an indicator (e.g., visual indicator). For instance, in FIG. 2A, the position selections (110a), (110b) are visualized as spherical touchpoints. Each spherical touchpoint may be given default and/or adjustable settings (e.g., size, color and name).

In other examples, the position selections are automatically determined, i.e., rather than being user selectable. For example, as explained below, the position selections can be automatically determined based on landmarks identified in the surrounding environment. That is, the system can analyze the sensor data—from the image and/or depth sensor—to identify target specific landmarks (e.g., body parts). These landmarks are then assigned as the position selections.

At (312a), the input 2D image is transformed to generate a transformed image. The process of transforming the 2D image is explained in method (300b) (FIG. 3B).

The transformed image comprises the original input 2D image, but with a number of transformed (or modified) configuration parameters. For example, the original 2D image is scaled, positioned and/or rotated, to match and align the image anchor points (108a), (108b) to the position selections (110a), (110b).

The transformed image is also deformed to have a 3D geometric profile, that substantially matches the contour of the target placement area (e.g., target placement area (252) in FIG. 2C). In this manner, the transformed image is also referred to herein as a contour-corrected image. The contour-correct image can accordingly warp around a deformed surface.

At (314a), the transformed image is superimposed over the target placement area, determined at (310a).

At (316a), one or more image configuration parameters can be adjusted or modified. By way of non-limiting example, the adjustable parameters can include: (i) image scale, (ii) image orientation, (iii) image position, and/or (iv) image transparency level. Adjusting the configuration parameters can involve, for instance:

(i) Image re-scaling, re-orientating and/or re-positioning: For example, in FIG. 2A, the user can interact with the visual touchpoints by moving them into new positions. This allows the user to re-scale, re-orient and/or re-size the superimposed 2D image. When the touchpoints are placed in a new position, they define new position selections. Accordingly, the above process is repeated, automatically, with the result that a new or updated transformed image is generated having update configuration parameters.

(ii) Image transparency level: The image transparency can be adjusted to make the image more transparent or opaque. For example, the user can interact with a GUI of the application (e.g., via input interface (614) (FIG. 6)), to modify or adjust the transparency level. For example, the GUI may include a feature to change the alpha value of the texture so that physical objects (e.g. the users' hands, pen marks on the skin, instruments) can be visualized between the transformed and superimposed image, and the real world.

In some examples, the configuration parameters are updated in real-time, or near real-time. That is, once user inputs are received for adjusting certain configuration parameters, the transformed image—displayed on user device (102)—is automatically update in real-time, or near real-time.

### (ii.) Generating Transformed Images

Reference is now made to FIG. 3B, which shows an example method (300b) for generating a transformed image, from an input 2D image. Method (300b) provides an example implementation for act (312a), of method (300a) (FIG. 3A). Method (300b) can be performed by processor (602), of user device (102) (FIG. 6).

At (302b), for each position selection (e.g., touchpoint), the two-dimensional (2D) coordinates of that position selection are determined. For example, this can comprise (x,y) coordinates corresponding to the pixel location, of that position selection, on the image feed displayed on the user device.

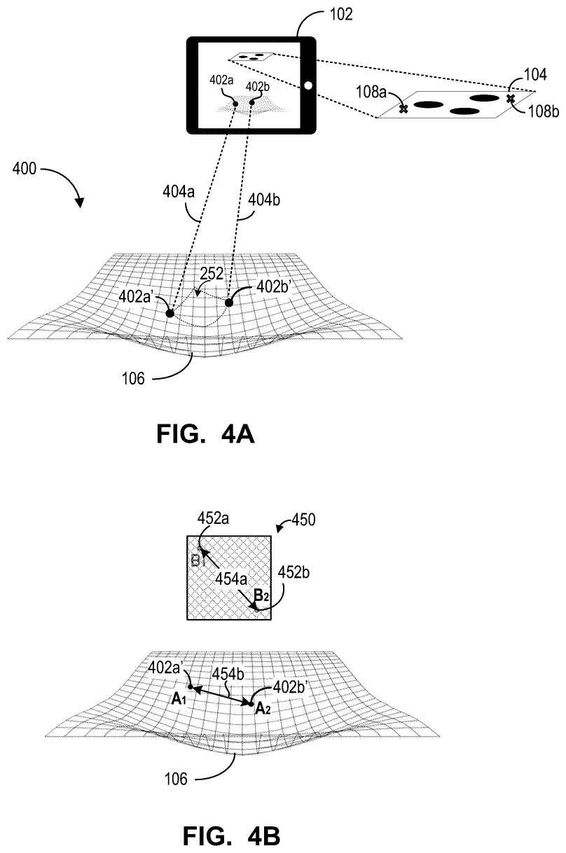

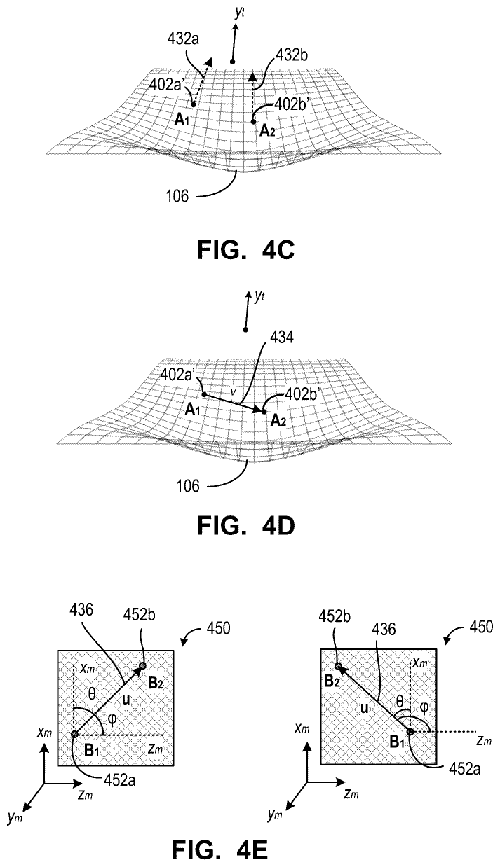

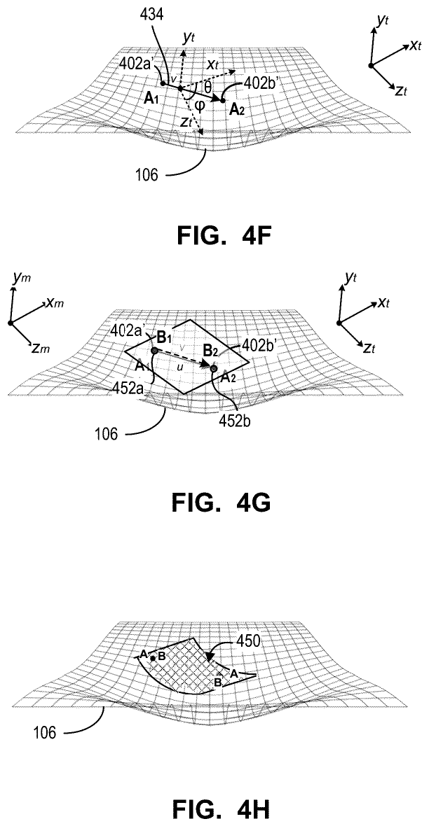

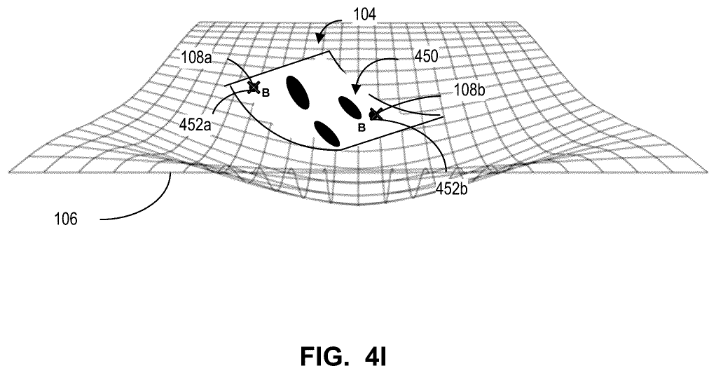

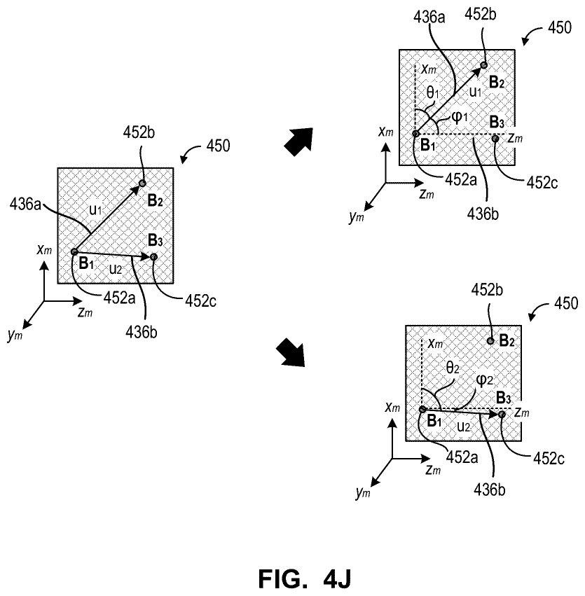

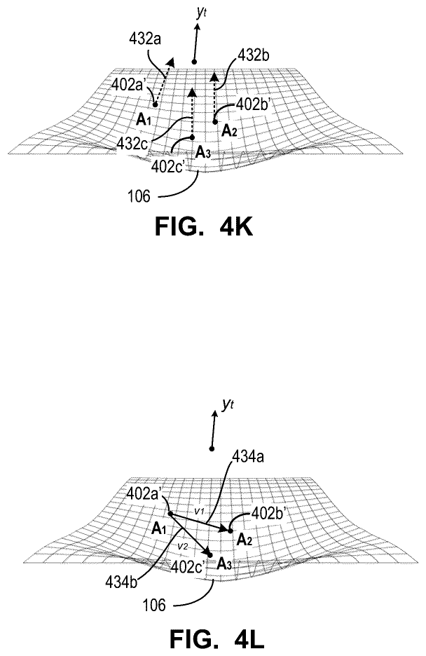

For instance, in FIG. 4A, the user has input two position selections (402a), (402b) on the displayed image feed of target surface (106). Each position selection (402a), (402b) is associated with a separate 2D coordinate (x, y), defined with respect to the image frame.

At (304b), each 2D coordinate, determined at act (302b), is converted into a corresponding 3D coordinate (e.g., x, y, z), projected onto the 3D world mesh of the surrounding environment, i.e., act (308a) in FIG. 3A.

For instance, in the example of FIG. 4A, this can involve transforming 2D coordinates for position selections (402a), (402b) to corresponding 3D coordinates (402a′), (402b′) projected on the 3D world mesh of target surface (106).

In at least one example, the conversion from 2D to 3D coordinates is effected by generating a ray (e.g., a straight line) (404a), (404b) from the camera (e.g., in the user device) to the intersection of the nearest point on 3D world mesh representing the imaged environment, e.g., using a technique known as ray casting. For example, this can be performed by invoking a RayCast function, such as those available in Apple® RealityKit® SDK (Software Development Kit). This process is repeated for each position selection (402a), (402b).

Accordingly, each position selection is associated with a respective projected 3D coordinate (402a′), (402b′). The 3D coordinate identifies the location of the position selection on the 3D world mesh.

As explained above, with respect to (310a) (FIG. 3A), once the position selections are received, they can also be visualized using an indicator (e.g., visual indicator). For instance, these include spherical touchpoints (FIG. 2A). It will now be understood that generating the visual indicator is possible once the position selections are associated with the 3D coordinates. That is, the indicators (e.g., spherical touchpoints) can be displayed and overlaid on the 3D world mesh, at the correct 3D positions.

At (306b), a new mesh portion is generated. This is shown, by way of example, in FIG. 4B, which illustrates a new mesh portion (450). As explained herein, the new mesh portion is used for superimposing the 2D image onto the target surface (106).

In more detail, the new mesh portion (450) is initially generated as a flat, 2D wire mesh (also referred to herein as a “planar wire mesh portion”, or “planar mesh portion”). In some examples, similar to the real-world mesh, the mesh portion (450) is generated as a series of polygons comprising a plurality of connected vertices, each vertex having a corresponding 3D coordinate.

The mesh portion is generated with two or more mesh anchor points (452a), (452b)—also denoted as B₁ and B₂. The mesh anchor points (452a), (452b) are selected at the same location, as the image anchor points in the input 2D image (104) (e.g., (108a), (108b) in FIG. 1). For example, if the image anchor points (108a), (108b) are selected as opposite corners of the 2D image, then the mesh anchor points (452a), (452b) are likewise selected as the opposing corners of the rectangular mesh. In other examples, the mesh anchor points (452a), (452b) are selected at an intermediate point, within the mesh portion (450), i.e., to mirror the anchor point selection in the 2D image (104). Here, it is understood that an equal number of mesh anchor points are generated, as image anchor points.

The physical size dimensions of the mesh portion (450) (e.g., height (H)×width (W)) may be determined based on the 3D coordinates, of the position selections (e.g., (402a′), (402b′) in FIG. 4A), i.e., on the target surface (106).

More generally, as shown in FIG. 4B, a first separation distance (454a) is determined between the mesh anchor points (452a), (452b). A second separation distance (454b) is determined between the position selections (402a′), (402b′). In some embodiments, the second separation distance (454b) is a Euclidean distance determined between the 3D coordinates, of the position selections (402a′), (402b′).

As explained herein, in some examples, the first separation distance (454a) is modified until it is substantially equal to the second separation distance (454b). The first separation distance (454a) may be modified by re-sizing the mesh portion (450) and scaling the vertices of the mesh portion (450).

As used herein, scaling vertices refers to adjusting the spacing in-between the vertices (e.g., decreasing or enlarging the spacing), such that that the total physical size dimension (H×W) of the planar mesh portion (450) is adjusted.

In some examples, the re-sizing and re-scaling is performed during act (308b), as explained below.

The new planar mesh portion (450) also has a density property (i.e., vertices per unit area). In at least one example, the mesh density is determined by the pixel density of the input 2D image (i.e., act (302a) in FIG. 3A). For example, the density of the mesh portion (450) may be substantially equal to the pixel density of the input 2D image. As explained the matching of the mesh density to the pixel density, facilitates adding texture to the mesh (450) (e.g., superimposing the 2D image on the mesh portion), and ensuring that the aspect ratio of the 2D image is consistent.

At (308b), the mesh anchor points (452a), (452b), of the mesh portion, are aligned with the corresponding position selections (402a′), (402b′), defined on the 3D mesh of the target surface (106). This, in turn, generates an aligned planar mesh portion (450).

In at least one example, aligning of the mesh portion (450) comprises a multi-act process. This is exemplified with reference to FIGS. 4C to 4E, which illustrate the alignment process in ordered sequence. At a general level, the aligned planar mesh (450) is generated by determining a common coordinate system (e.g., a common cartesian coordinate system) between the image mesh (450) and the target surface (106). This allows orientating the mesh (450) to align with the target surface (106), irrespective of the original position and/or orientation of the mesh (450) relative to the target surface (106).

As shown, at FIG. 4C, the alignment process begins by partially determining a “target surface coordinate system” defined with respect to the target surface (106), having three orthogonal axes (xₜ, zₜ, and yₜ). Initially, in FIG. 4C, only a first normal axis (yₜ) is defined with respect to the target surface (106). This axis is generally orthogonal to the plane of the target surface (106). Defining this normal axis involves, (i) first, determining a normal vector (e.g., orthogonal vector) with respect to the target surface (106), and at each selection point (402a′), (402b′). In FIG. 4C, this is shown as normal vectors (432a), (432b); and (ii) second, averaging the normal vectors (432a), (432b) to generate the normal axis (yₜ). At this point, the other two axis (e.g., the z-axis and x-axis), of the target surface coordinate system, are undefined.

At FIG. 4D, a vector (v) (434) is determined, and which extends between the first position selection (402a′) and the second position selection (402b′) on the target surface (106). To this end, the system designates one of the position selections as being the first selection (402a′), and the other one being the second selection (402b′). The vector (v) extends from the first to the second position selection, as determined by subtracting the 3D position of the second position selection from the first position selection.

At FIG. 4E, in respect of the image mesh (450)—an image mesh coordinate system is defined with respect to the mesh portion (450), and having three orthogonal axes (xₘ, zₘ, and yₘ).

Irrespective of the original orientation of the image mesh (450), the image mesh (450) is defined to extend in the (xₘ, zₘ) plane. Further, the third axis (yₘ) is defined to be normal (e.g., orthogonal) to the (xₘ, zₘ) extension plane.

A vector (u) (436) (FIG. 4E) is defined to extend between the mesh anchor points (452a), (452b). The vector (u) (436) extends from the first anchor point (452a) to the second anchor point (452b), by subtracting their 3D positions. The first and second anchor points (452a), (452b) are defined such that they match the first and second selection points (402a′), (402b′). That is, when the mesh is aligned, the first anchor point (452a) is aligned with the first position selection (402a′), and so forth, i.e., in the intended or desired manner.

Continuing with reference to FIG. 4E, the angular offset between the vector (u) and the first axis (xₘ) is defined as angle (0), while the angular offset between the vector (u) and the second axis (zₘ) is defined as the angle (y). FIG. 4E illustrates two examples of how to determine the offset angles (0, p), depending on how the vector (u) (436) is defined.

At FIG. 4F, the target surface coordinate system is further defined, by defining the remaining axis (xₜ, zₜ) which extend in a plane orthogonal to the normal axis (yₜ). This is performed by applying the offset angles (θ, φ) to the vector (v) (434).

For example, to determine the first axis (xₜ)—a rotation is applied, in a plane orthogonal to the normal axis (yₜ), around the normal axis (yₜ) by the offset angle (θ). Likewise, to determine the second axis (zₜ)—a rotation is applied, in a plane orthogonal to the normal axis (yₜ), around the normal axis (yₜ) by the offset angle (y). The rotation and offset angles can be applied in the same rotation direction, as in the mesh portion (450), with respect to the direction of the vectors (u, v). In this manner, the target surface coordinate system is now defined.

At FIG. 4G, having defined each of the target surface and mesh coordinate systems, the mesh portion (450) is aligned with the target surface (106). This is performed by aligning the two coordinates systems with each other, and more generally, aligning each of the normal axis (yₜ), (yₘ) together, and further aligning the same first and second axis together, e.g., (xₜ), (xₘ) and (zₜ), (zₘ). In doing so, the mesh portion (450) extends uniformly along the (xₜ), (zₜ) and (xₘ), (zₘ) planes.

In this aligned coordinate system, the mesh portion (450) can be rotated and translated such that the vector (u) (436) is aligned (e.g., extends conterminously, in the same direction in three-dimensional space) with the vector (v) (434). In some examples, this involves scaling the dimensions of the mesh portion (450) such that the vector (u) (436) extends by an equal length as vector (v) (434). In other examples, the scaling is performed ahead of time, as discussed above.

Further, the aligning may also involve applying one or more linear transformation matrices to the vertices of mesh (450) such that the mesh portion (450) is translated into an alignment configuration, whereby the vectors (u), (v) are aligned. This can involve determining one or more linear translation and rotation matrices to translate the mesh (450) from an initial unaligned position and orientation (FIG. 4B), to the final aligned position and orientation (FIG. 4G).

It is observed in FIG. 4G, that in the aligned position configuration, each mesh anchor point (452a), (452b) is aligned with the corresponding position selection (402a′), (402b′), e.g., each mesh anchor point (452) is located in an identical 3D coordinate position as the corresponding position selection (402).

Returning to FIG. 3B, at (310b), the aligned mesh portion (450) is deformed to generate a contour-corrected mesh portion (450), with respect to the 3D mesh defining the target surface (106) (see e.g., FIG. 4H).

If the aligned mesh portion is superimposed over a horizontal surface, act (310b) may involve generating at least one ray from each vertex of the aligned mesh portion (450), downward toward the 3D mesh (106) (e.g., using ray casting). If an intersection point is identified with the 3D mesh, along the ray—then the corresponding mesh (450) vertex is moved down to that point. By iterating this for each vertex for the aligned mesh portion (450), the result is that the aligned mesh portion (450) is a contour-corrected mesh portion, which is superimposed over the 3D world mesh and hovers just off its surface.

In at least one example, the maximum ray distance moved by any vertex is recorded. This allows vertices, that did not intersect any 3D world mesh (106), to move that same distance. This act may be performed to smoothen the image.

In some other examples, deforming the mesh is also performed using homography or affine transformation matrices. The Moving Least Squares algorithm, rigid transformation, and similarity transform can be used to transform individual points within an image, ensuring that key points (such as joints) end up where they need to be.

It may also be desirable to orient the mesh portion (450) in a non-horizontal orientation, e.g., if the target surface (106) is not horizontally oriented. If the mesh portion (450) is to be placed in a vertical orientation, the normal for each vertex must be determined by taking the cross-product between two adjacent vertex pairs at 90 degrees to each other. Rays are then generated along the normal toward the vertical 3D world mesh. If the ray finds an intersecting point, the vertex of the superimposed mesh portion (450) is moved along the normal to that intersecting point. The maximum ray distance a vertex moves may be again recorded, to allow for the vertices that did not intersect the 3D world mesh to move that same distance.

At (312b), within the contour-corrected and superimposed mesh portion (450), each three perpendicular vertices are used to build a triangle. This process is repeated to subdivide the contour-corrected mesh (450) completely into triangles, where two triangles generate a square and the resulting series of squares is the size of the 2D image.

In some examples, this series of triangles is converted into a texture (e.g., using existing functions in RealityKit®). This involves “pasting” the 2D image onto the contour-corrected mesh portion, to generate a textured mesh portion. The result is that the 2D image is placed on the desired surface of the real world (e.g., flat or curved) and has been properly adjusted for position, size and curvature.

For example, as shown in FIG. 4I, the 2D image (104) is “pasted” onto the contour-corrected and superimposed mesh portion (450), thereby “texturing” the mesh portion (450). When the mesh portion (450) is textured with the image (104), the image anchor points (108a), (108b) are also positionally aligned with the mesh anchor points (452a), (452b), as shown. This, in turn, completes the process and generates an image warped over the deformed surface (106). Further, as the mesh portion (450) has a density equal to the pixel density of the 2D image, the textured mesh portion should have a consistent aspect ratio.

In some examples, act (312b) is performed prior to act (310b). That is, the mesh can be colored prior to deforming the mesh.

### IV. Other Examples

The following is a discussion of other examples relating to the disclosed methods and systems.

### (i.) Real-Time or Near Real-Time Updating

The system may be configured to preforms methods (300a) and (300b), in real-time or near real-time. For example, the system may continuously update the configuration of the superimposed transformed image to respond to movements of the user device (102) and/or target placement area.

For example, if the user device (102) moves, and generates a new perspective of the surrounding environment, it can appear that the 2D remains in place, at scale and correctly deformed to match the surface in the real world. This is possible at any viewing angle as long as the touch points remain in view.

In a case where the user device (102) remains stationary, and the target surface, where the 2D image is placed, subsequently moves, the touch points identified by the rays, and their subsequent calculations, are updated.

If the motion of the real-world object is continuous, the position selections (e.g., touchpoints) may be updated constantly (e.g., in real-time or near real-time) (e.g., act (302b) in FIG. 3B). In this case, additional SDKs can be used to identify recognizable reference points, and track these references points as they move. For example, the reference points can correspond to features on a human subject (e.g., eyes, shoulders, hips) or on other objects (e.g. cars), depending on the application. As a result, the position of the position selections can then be updated and adjusted with respect to the location of the reference points. Accordingly, any position selections identified by the user can be tracked if the real world object is moving. In this way, the 2D image of choice can be placed on an object and remain placed correctly on the object as the object moves within the real world in relation to the device.

### (ii.) Multiple Images

In FIGS. 3A and 3B, methods (300a) and (300b) are described in an example application where only a single 2D image is projected onto the surrounding environment. In other examples, however, the same concepts and principles may be applied to project multiple images, concurrently.

For example, methods (300a) and (300b) can enable multiple 2D images to be represented in the real world, as viewed through the user device (102). In these examples, methods (300a) and (300b) are repeated for each image. Additional touch points can be provided so that the multiple images appear in different locations around the real world. As described previously, each image could have its own image-specific configuration parameters (e.g., transparency level, scaling size, orientation, etc.).

In at least one example, it is possible to stack multiple images at any two or more position selections. In this case, a user can control the display distance between the image layers, as well as the transparency level, so that each image may be seen individually, or many images may be seen together. The user may also re-scale and reposition the stack of images, in the same manner as described previously. In some examples, the user may shuffle the images within the stack to change their order of appearance.

### (iii.) Medical Application

Clinicians often evaluate diagnostic imaging separately from the patient. This creates significant problems including medical errors and dehumanizing patients.

In at least one example application, the disclosed embodiments are used to project anatomically correct diagnostic images (e.g., X-rays, CT scans or MRI images) onto the skin of a patient. This can allow a user to observe where various bones, muscles, tissues, and organs are located on the actual body. In some cases, this can help guide medical procedures (e.g. injections).

By way of example, an input image can correspond to an X-ray of a subject's left femur, which is disposed between the subject's left hip joint and left knee joint. In this example, the image anchor points (108a), (108b)—and by extension, the mesh anchor points (452a), (452b)—are selected (e.g., manually or automatically) to correspond to the location of the left hip joint and left knee joint, i.e., in the input image. Further, the position selections (402a′), (402b′) in the real-world environment are also selected (e.g., manually or automatically) to be the left hip and knee joint on the actual subject (referred to herein as “joint position selections” (402)). This, in turn, enables superimposing the X-ray image onto the correct portion of the subject's body. While this example uses two joint locations, it is also possible to more generally align the diagnostic image to one or more joint locations on the subject's body.

In some examples, the image and mesh anchor points (108), (452) are selected manually or automatically in the input diagnostic image.

In the case of manual selection, the user can manually select (e.g., on user device (102)), the relevant joints in the input image. In turn, the selected joints are designated as the image and mesh anchor points (108), (452).

In other examples, the image and mesh anchor points (108), (452) are selected automatically in the input image. For example, an image processing algorithm (as may be known in the art) can automatically analyze the input diagnostic image to determine and/or classify the location and/or type of specific joints. For example, the image analysis algorithm can analyze an X-ray of a subject's left femur to detect specific image features corresponding to the subject left hip or knee joints. Accordingly, these detected joints are automatically designated as the image and mesh anchor points (108), (452).

By a similar token, the joint position selections (402) in the real-world environment (e.g., on the subject's body) can also be performed manually or automatically.

In the case of manual selection, the user can observe the image feed of the subject's body (e.g., on the user device (102)), and can manually input or select joint position selections (402) associated with the location of target joints on the subject's body. For example, the user can select the subject's left hip and knee joints in the real-world image feed of the subject patient, as displayed on the user device (102).

In other examples, the joint position selections (402) are performed automatically or partially automatically. For example, a pose-detection algorithm can operate to automatically determine various landmarks on a subject's body (e.g., head and various joints) based on the image data received by the user device (102). The pose-detection algorithm can comprise various pose detection tool kits (e.g., OpenCV, Apple® Vision, Apple® PosNet, etc.). It is also possible that the geometric calculations are used to further localize certain joint positions (e.g., position of 3^{rd} lumbar vertebra (L3)).

Using this automated joint position detection, the user has several options to make the joint position selections. In at least one example, the user may input the type of joint (e.g., “left knee joint” and “left hip joint”), where the input diagnostic image should be aligned. In turn, based on the automatically detected joints, the system can assign the correct joint position selections (402).

In other examples, the user can insert or overlap (e.g. drag-and-drop) the input diagnostic image over the real-world image feed of the subject's body. The system can then automatically align (e.g., lock) the image into the correct position. For example, the user can drag an X-ray image of the subject's left femur, over the real-time image feed of the subject's left femur, e.g., using the user device (102). Based on the image placement area where the user inserts the diagnostic image (e.g., the area where the user dragged and dropped the diagnostic image), the system can identify joints that are most proximal to the image placement area. If the user inserts the X-ray image proximal the subject's left hip and knee joints in the image feed, the system can automatically select the left hip and knee joints as being the correct joint position selections (402), i.e., because of their proximity to the image placement area. The system can then automatically align (e.g., snap fit) the image anchor points (108) of the left hip and knee joints in the diagnostic X-ray image, to the displayed image feed of the subject's left hip and knee joints, respectively, by applying the process in FIGS. 4C to 4I, as explained above.

More generally, in some examples, when a user inserts (e.g., overlays) a diagnostic image over the image feed, the system can, (i) identify one or more joint positions that are within a predetermined proximity to the image placement area (e.g., as detected by pose-detection algorithm); and subsequently (ii) designate those proximal joint positions as the joint position selections (402) for the purposes of superimposing the image. In other examples, prior to step (i), the system can initially identify the type and/or number of image anchor points selected in the input diagnostic image. Subsequently, at step (i), the system identifies an equal number and/or type of joints in predetermined proximity to each mesh anchor point. For instance, if two image anchor points are selected in the diagnostic X-ray image, then the system can identify at least two joints in the image feed that are most proximal to the image placement area, and designate those as the joint position selections.

In at least one example, the system can provide joint tracking functionality. For example, as a subject moves, the superimposed image tracks the subject's movement such that the mesh anchor points (452) remain aligned with the joint position selections (402).

In some examples, the joint tracking is performed by monitoring the joint position selections (402)—corresponding to joints on the subject's body—over various time intervals. Each time a new location is detected for one or more joint position selections (402), the superimposed image is realigned and/or re-superimposed using the new location of the joint point selection(s) (402). For instance, this involves re-iterating acts (310a)-(316a), and by extension method (300b), each time a new location for a joint position selection is determined. The joint positions can be tracked, for example, using a pose-detection algorithm as known in the art. In some cases, to minimize the computational demand, the system can average the location of each joint position selections (402) over a specific pre-determined time frame (e.g., 60 Hz). The image and mesh are then re-aligned or re-superimposed to each averaged location of the joint position selections (402), over the pre-determined time frame. The averaging can mitigate small deviations in joint positions resulting, for instance, from micro-movements in the subject.

In some examples, an artificial intelligence (AI) model is trained to use pose detection data, together with human features (e.g., height, weight and sex). In turn, this can generate a custom machine learning model capable of estimating the target placement area on a subject's body, for a projected diagnostic image. The A.I. model can also be used for other applications, such as automatically determining image anchor points in the input 2D image, as described previously.

### (iv.) Multiple Position Selections and Anchor Points

In some examples, the method (300b) in FIG. 3B is effected using more than two position selections (402) and mesh anchor points (452). In an example medical application, as discussed above, this means that the method can be effected by aligning the diagnostic image to more than two joint positions.

In these examples, the process of generating the aligned mesh (450), at (308b) in FIG. 3B, is modified as follows:

First, with respect to the mesh portion (450), instead of defining a single vector (436) between the mesh anchor points (452a), (452b) (FIG. 4E), multiple vectors are defined. This is exemplified in FIG. 4J, whereby: (i) a first vector (u₁) (436a) is defined between a first anchor point (452a) and a second anchor point (452b); and (ii) a second vector (u₂) (436b) is defined between the first anchor point (452a) and the third anchor point (452c).

More generally, the system can select one of the anchor points to be the original “first” anchor point (452a), and it can determine one or more vectors (u) that extend from the first anchor point, and in the direction of each other anchor point. As also shown in FIG. 4J, in respect of each vector (u₁), (u₂), a corresponding set of offset angles are determined (θ₁, φ₁) and (θ₂, φ₂). These are called “vector-specific offset angles”.

Second, with respect to the target mesh (106), instead of averaging only two normal vectors (432a), (432b) to determine the normal axis (yₜ) (FIG. 4C)—as shown in FIG. 4K, the normal vector from each of the plurality of position selections (432a)-(432c) are now averaged to generate the normal axis (yₜ).

Further, rather than defining a single vector (v) (434) extending between the position selections (402a′), (402b′) (FIG. 4D)—as shown in FIG. 4L, a plurality of vectors (v₁) (434a), (v₂) (434b) are defined. Each vector (v) extends from a common first position selection (402a′), and in the direction of every other position selection (402b′), (402c′). The position selections are numbered in the same manner as the mesh anchor points, as explained above, to ensure a match between the two.

Third, in contrast to FIG. 4F where the offset angles (0, e) are applied only to the single vector (v) (434) to resolve the coordinate axis (xₜ, zₜ)—in the case of FIG. 4L, the vector-specific offset angles are applied to each corresponding vector.

For example, in FIG. 4L, the offset angles (θ₁, φ₁) from vector (u₁) are applied to vector (v₁), to resolve a first coordinate axis pair (xₜ₁, zₜ₁). Further, the offset angles (θ₂, φ₂) from vector (u₂) are applied to vector (v₂), to resolve a second coordinate axis pair (xₜ₂, zₜ₂). Here, it is noted the vectors are defined and matched (e.g., u₁, v₁) based on which mesh anchor points are intended to align with which position selections, such that the mesh anchor points and position selections are numbered in parallel and corresponding order.

Once each set of vector-specific axis are determined, these vector-specific axis are averaged to determine the direction of the final axis (xₜ, zₜ). For example, xₜ is the average of (xₜ₁, xₜ₂), while zₜ is the average of (zₜ₁, zₜ₂). As used herein, “averaging” the axis refers to find the average direction of the axis by, for example, treating each axis as a vector in 3D space.

The remainder of the alignment process is then performed as discussed previously, with the mesh being aligned over the target surface by aligning the two coordinate axis systems together.

To this end, if more than one position selection and mesh anchor are made—the system can designate which position selections are to be matched with which mesh anchor points, in order to effect the above method correctly. This can be performed by user selection, or automatically by analyzing which mesh anchor points should align with which position selections on the target surface (e.g., by matching the imaged joints, to the real-world joints, in a medical application).

### (v.) Metal Performance Shader

In at least some examples, in FIG. 3B, act (306b) is not applied to generate a new mesh portion, and (308b) is not used to deform the mesh portion (450). Rather, the alignment at (308b) is performed directly on the pixels in the input image (e.g., applying the above methods to the pixel coordinates, rather than the vertex coordinates in the mesh portion). Further, a metal shader is generated for the world mesh and anchored to the position selections (402) on the world mesh using points generated from the ray casting (e.g., using a CPU). The remaining points are then determined using, for example, a “Moving Least Squares” algorithm (e.g., using a GPU). In this case, the image is displayed on the world mesh, as opposed to its own mesh.

### (vi.) Other Example Systems

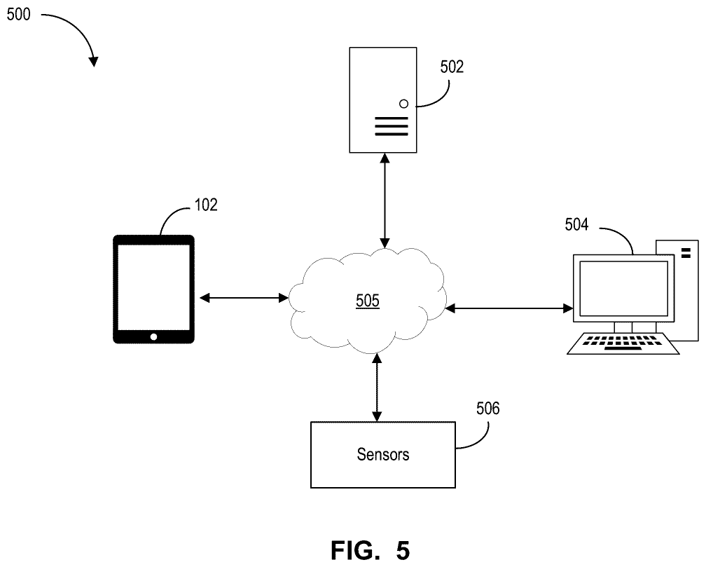

FIG. 5 shows an example system (500) for superimposing a two-dimensional (2D) image onto a deformed surface.

As shown, the system includes the user device (102) which may be connected, via network (505) to one or more external servers (502) (e.g., cloud servers) and/or remote computing devices (504).

In these examples, server (502) and/or computing device (504) may perform all, or any portion, of the methods described herein. For example, once images and/or sensor data are captured by the user device (102), the raw or partially-processed sensor data is transmitted to the servers (502) and/or computing device (504). The server and/or computing device (504) can process the data (e.g., raw or partially processed) to generate the superimposed 2D image. The superimposed 2D image can then be transmitted back for display on the user device (102). In other examples, the superimposed 2D image can be displayed directly on another computing device, including the computing device (504).

In some examples, the server (502) and/or computing device (504) can also return partially processed data, back to the user device (102). The partially processed data is then further processed by the user device (102).

The server (502) and/or computing device (504) can also store various data required for the described methods. For example, the server (502) and/or computing device (504) can store or archive various images that can be superimposed (e.g., a library of images). The user device (102) can therefore access (e.g., retrieve or receive) the 2D images from the server (502) and/or computing device (504).

System (500) may include sensors (506). These can be included in addition to, or in alternative, to the user device (102). The sensors can include one or more 2D imaging sensors (e.g., imaging sensors (606) in FIG. 6) and/or 3D imaging sensors (e.g., (608) in FIG. 6). The data from these sensors can be transmitted to one or more of the components in the system (500) for processing, in accordance with the methods described herein.

In at least one example, the sensors (506) are provided in addition to the user device (102). For example, this may be the case where the user device (102), itself, does not include one or more of the required sensors. It is also possible that the user device (102) has one type of sensor (e.g., 2D imaging sensor), but lacks the other type of sensor (e.g., 3D depth sensor). In these cases, concurrently captured data from the user device (102) and sensors (506) is combined in accordance with disclosed methods.

In still other examples, the sensors (506) are provided in alternative to the user device (102). Here, it is appreciated that the disclosed methods can be performed using external sensors, insofar as the system has a processor for processing the sensor data. For example, the output of the sensors (506) can be transmitted, via network (506), to the computing device (504) for further processing and display of the superimposed 2D images.

Communication network (505) can be an internet, or intranet network. In some examples, network (505) may be connected to the internet. Typically, the connection between network (505) and the internet may be made via a firewall server (not shown). In some cases, there may be multiple links or firewalls, or both, between network (505) and the Internet. Some organizations may operate multiple networks (505) or virtual networks (505), which can be internetworked or isolated. These have been omitted for ease of illustration; however it will be understood that the teachings herein can be applied to such systems. Network (106) may be constructed from one or more computer network technologies, such as IEEE 802.3 (Ethernet), IEEE 802.11 and similar technologies.

### V. Example Hardware Configuration for User Device

Reference is made to FIG. 6, which shows an example hardware configuration for a user device (102).

As shown, the user device (102) can include a processor (602) coupled to a memory (604) and one or more of: (i) imaging sensor(s) (606), (ii) 3D sensors (608), (iii) communication interface (610), (iv) display interface (102a), and/or (v) input interface (614).

Imaging sensor(s) (606) can include any sensor for capturing two-dimensional (2D) images. For instance, this can be a camera for capturing color images (e.g., Red Green Blue (RGB) camera), grey-scale or black-and-white images.

Three-dimensional (3D) sensor(s) (608) can comprise any suitable sensor for collecting depth data. For instance, this can include any time of flight (ToF) sensor, such as a Light Detection and Ranging (LiDAR) sensor.

Communication interface (610) may comprise a cellular modem and antenna for wireless transmission of data to the communications network.

Display interface (102a) can be an output interface for displaying data (e.g., an LCD screen).

Input interface (614) can be any interface for receiving user inputs (e.g., a keyboard, mouse, touchscreen, etc.). In some examples, the display and input interface or one of the same (e.g., in the case of a touchscreen display).

To that end, it will be understood by those of skill in the art that references herein to user device (102) as carrying out a function or acting in a particular way imply that processor (602) is executing instructions (e.g., a software program) stored in memory (604) and possibly transmitting or receiving inputs and outputs via one or more interfaces.

In embodiments which include other computing devices (e.g., server (502) and/or a computer terminal (504) in FIG. 5), these components can also have an analogous hardware configuration, as shown in FIG. 6. For example, these components may also include a processor coupled to a memory. In some examples, they may also include one or more of a communication interface, display interface and/or an input interface, among other components.

### VI. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for superimposing a two-dimensional (2D) image onto a surface, comprising:
pre-processing the 2D image to generate a pre-processed 2D image, wherein the pre-processing comprises assigning one or more pixels in the 2D image as one or more image anchor points;
receiving image data and depth sensor data, of a surrounding environment, from at least one sensor;
processing the depth sensor data to generate a three-dimensional (3D) wire mesh;
determining a target placement area, on the 3D world mesh, for superimposing the 2D image, wherein the target placement area is located on a deformed surface; and
superimposing the transformed image over the target placement area.

2. The method of claim 1, wherein the deformed surface has a degree of curvature.

3. The method of claim 1, wherein the target placement area is determined by specifying one or more position selection points and the transformed image is superimposed by aligning the one or more anchor points with the one or more position selection points.

4. The method of claim 3, wherein the one or more image anchor points are designated as one or more image corners.

5. The method of claim 1, wherein two or more 2D images are superimposed and the pre-processing step, the target placement area determination step and the image superimposition step are repeated for each additional 2D image.

6. The method of claim 5, further comprising specifying different position selection points for the two or more 2D images.

7. The method of claim 1, wherein the 2D image or each 2D image is adjusted to a desired transparency level, scaling size, and orientation.

8. The method of claim 1, wherein the target placement area is determined automatically.

9. The method of claim 8, wherein the automatic determination of a target placement area comprises a pose-detection algorithm for determining at least one landmark or feature on the surface.

10. The method of claim 9, further comprising the step of geometrically calculating the position of the at least one landmark or feature.

11. A system for superimposing a two-dimensional (2D) image onto a deformed surface, comprising:
at least one sensor configured to generate image data and depth sensor data;
a projector for superimposing the 2D image over the target placement area; and
at least one processor configured for:
pre-processing the 2D image to generate a pre-processed 2D image, wherein the pre-processing comprises assigning one or more pixels in the 2D image as one or more image anchor points;
receiving image data and depth sensor data, of a surrounding environment, from at least one sensor;
processing the depth sensor data to generate a three-dimensional (3D) wire mesh;
determining a target placement area, on the 3D world mesh, for superimposing the 2D image, wherein the target placement area is located on a deformed surface; and
superimposing the transformed image over the target placement area.

12. The system of claim 11, wherein the deformed surface has a degree of curvature.

13. The system of claim 11, wherein the target placement area is determined by specifying one or more position selection points and the transformed image is superimposed by aligning the one or more anchor points with the one or more position selection points.

14. The system of claim 13, wherein the one or more image anchor points are designated as one or more image corners.

15. The system of claim 11, wherein two or more 2D images are superimposed and the pre-processing step, the target placement area determination step and the image superimposition step are repeated for each additional 2D image.

16. The system of claim 15, wherein the at least one processor is further configured for specifying different position selection points for the two or more 2D images.

17. The system of claim 11, wherein the 2D image or each 2D image is adjusted to a desired transparency level, scaling size, and orientation.

18. The system of claim 11, wherein the target placement area is determined automatically.

19. The system of claim 18, wherein the automatic determination of a target placement area comprises a pose-detection algorithm for determining at least one landmark or feature on the surface.

20. The system of claim 19, wherein the at least one processor is further configured for the step of geometrically calculating the position of the at least one landmark or feature.
